(19) United States
(12) Patent Application Publication
(10) Pub. No.: US 2014/0214591 A1
(43) Pub. Date: Jul. 31, 2014

(54) SYSTEM AND METHOD TO PROVIDE A PRODUCT DISPLAY IN A BUSINESS

(71) Applicant: Vijayachandra Sriram Kotinaga, San Jose, CA (US)

(72) Inventor: Vijayachandra Sriram Kotinaga, San Jose, CA (US)

(73) Assignee: eBay Inc., San Jose, CA (US)

(21) Appl. No.: 13/755,405

(22) Filed: Jan. 31, 2013

(51) Int. Cl. G06Q 30/06

(52) U.S. Cl. CPC G06Q 30/0631
USPC 705/26.7

(57) ABSTRACT

A system, method and article of manufacture for displaying products in association with a merchant business. The merchant is provided with code, such as code for a carousel-like display, for integration with the merchant's business, for displaying products. The merchant integrates the code into his or her business, such as by installing the code on the merchant's website. A listing of the products offered by the merchant is received by an ecommerce system. Upon query related to a product offered by the merchant, a listing of products related to the queried product is provided by an ecommerce system. Those related products are compared to the products offered by the merchant. The related products that are not the same as or equivalent to products offered by the merchant are communicated for display in association with the merchant's business by the code. The displayed related products may be purchased from sellers on the ecommerce system via the business.

### TECHNICAL FIELD

This application relates to a method and system to provide a product display in the form of a scrolling carousel-like display for integration into a merchant's business.

### BACKGROUND

Some businesses, because of their size or otherwise, do not carry all product related-items, such as accessories, for products the businesses offer. Some of these businesses would appreciate having their customers referred to sellers of accessory items that the businesses themselves to not offer.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a network diagram depicting a client-server system, within which one example embodiment may be deployed;

FIG. 2 is a block diagram of a system to provide a scroll map of search results, in accordance with one example embodiment;

FIG. 3 is a flow chart of a method to provide a scroll map of search results, in accordance with an example embodiment;

FIG. 4 shows an example scroll presentation, in accordance with an example embodiment;

FIG. 5 shows an example user interface to display a thumbnail image of a bookmarked listing, in accordance with an example embodiment;

FIG. 6 is a flow chart of a method of providing certain products for display in accordance with one example embodiment;

FIG. 7 is a diagram of a user interface, according to one example embodiment, for display and selection; and

FIG. 8 is a diagrammatic representation of an example machine in the form of a computer system within which a set of instructions, for causing the machine to perform any one or more of the methodologies discussed herein, may be executed.

### DETAILED DESCRIPTION

An on-line trading platform allows users to shop for almost anything using a web browser application. A user may find an item listed by an on-line trading application by entering keywords into the search box provided on an associated web page or by browsing through the list of categories on the home page. After a list of search results is returned, a user may further refine a search using a list of filters provided in the right-side portion of the search results web page. A user may select an item from the search results to view the details of the item. A user may then return to the search results page to further refine the search by using filters provided in the right-side portion of the search results web page.

A system, method, and article of manufacture to provide a product display integrated into an electronic business is described. The display may be, in one embodiment, a scroll map of search results in the context of on-line trading. In the following description, for purposes of explanation, numerous specific details are set forth in order to provide a thorough understanding of an embodiment of the present invention. It will be evident, however, to one skilled in the art that the present invention may be practiced without these specific details. Embodiments of the present invention include approaches that enhance user's experience by permitting a user to quickly identify previously selected items presented as an scrollable list, which may be implemented to be scrolled horizontally or vertically as desired. In one embodiment the presentation may be via carousel software code, which may be written in Java Script and HTML, which is coupled to an ecommerce system's servers. Merchants can integrate the code into their business. The servers may be viewed as remote from the merchant's business. In one embodiment the code may be integrated into a merchant's web site. An ecommerce system's remote servers may then provide listings of products that are related to, but not competitive with, products offered by the merchant, effectively augmenting the merchant's product line. These listings may then be displayed in the form of film strip in the merchant's website, or otherwise displayed for the merchant's customers. Customers of the merchant may then buy the related products, advertised by the ecommerce system, from the ecommerce system's sellers via from the merchant's website. In other embodiments, the related products may be displayed on a user interface on a display of any type and size, which may be located in the merchant's physical store. The related products may then be selected for purchase or for other purposes by using selection processes via a client machine such as a laptop, stationary computer, or mobile device. The selection using a mobile device may be by search as described in U.S. patent application Ser. No. 12/276,274 entitled Systems and Methods to Search with a Mobile Device, filed Nov. 12, 2008 and assigned to the assignee of this patent, which is incorporated by reference in its entirety. Selection may also be performed in the merchant's physical store using well known near field communication techniques between the mobile device and the display. Further, the products may be displayed within a store in an on-line mall such as the on-line mall described in U.S. Pat. No. 7,689,462, issued on Mar. 30, 2010, entitled Computer System and Method for Providing an On-Line Mall, assigned to the assignee of this patent, and incorporated herein by reference in its entirety.

In one embodiment, if desired, in response to a search request, e.g., with respect to listings accessible in the context of an on-line trading platform, the search results are displayed in the form of a scrollable list of items that satisfy the search criteria. A user may scroll through the items (listings) presented in the scrollable list and select one or more items that may be of interest or for future reference. The selection in this scenario may be referred to as bookmarking or tagging. As the user bookmarks an item in the scrollable list, a marker (also referred to as an annotation) appears on the scroll bar. The effect of such bookmarking is what may be termed a scroll map of the tagged/marked listings, as the user can follow the marks on the scroll bar to faster access or preview those items that she previously marked as being of potential interest. This technique may be particularly beneficial when the scrollable list contains a great number of items for display

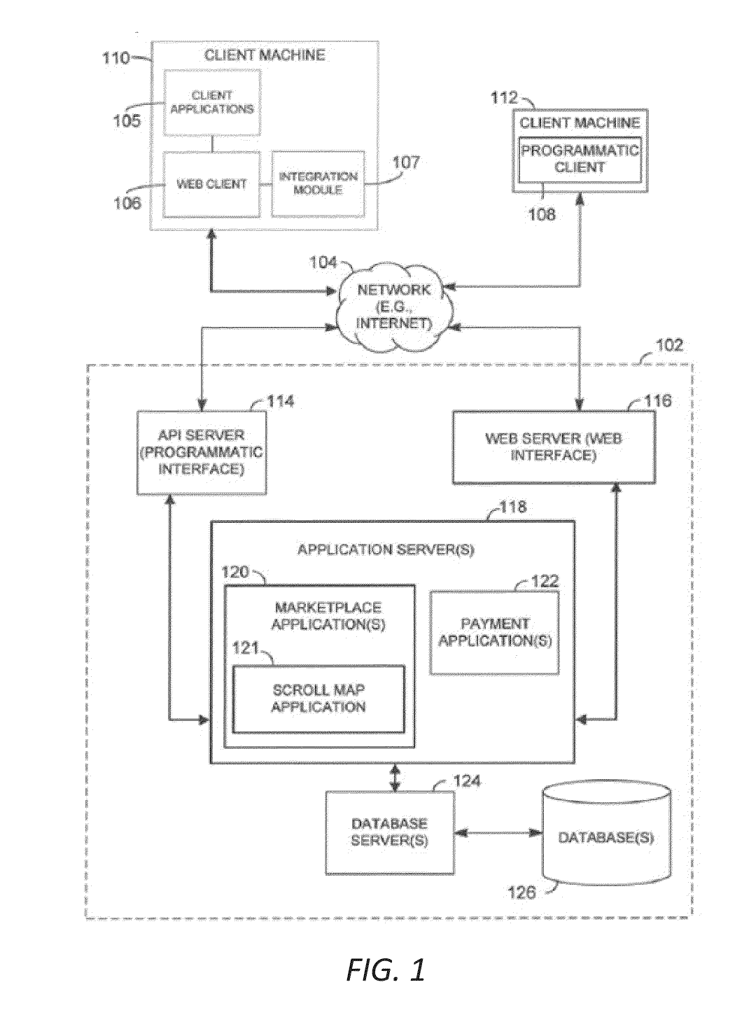

It will be noted, that, while some embodiments are being described with reference to search results comprising item listings in the context of an on-line trading platform, the techniques described herein may be used beneficially with respect to displaying any scrollable list or other displays, where, at least for the scrollable list embodiment, a user is permitted to select and bookmark/tag items from the list. Example method and system to provide a scroll map of search results in the context of on-line trading may be implemented in the context of a network environment 100 illustrated in FIG. 1, specifically as a scroll map application 121.

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or Wide Area Network (WAN)) to one or more clients. FIG. 1 illustrates, for example, client applications 105 (e.g., mobile applications), an integration module 107, and a web client 106 (e.g., a mobile or desktop Web browser) operating on the client machine 110 (e.g., a laptop, stationary computer, or mobile device), as well as a programmatic client 108 operating on the client machine 112.

An application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of marketplace functions and services to users that access the networked system 102. Shown in FIG. 1 is a scroll map application 121 included as one of the marketplace applications 120. The scroll map application 121 may be utilized beneficially to present information markers on the scroll bar portion of a scrollable presentation of information items and also provide a preview of marked items.

In one example embodiment, as mentioned above, a scrollable presentation of information items may be a list of search results provided in response to a search request in the context of an on-line trading platform. As a user scrolls through the search results, e.g., using an ‘infinite’ scroll where no pages are required, a scroll map system (e.g., the scroll map application 121 of FIG. 1) permits the user to select and mark those listings from the search results that may be of further interest to the user for purchase or otherwise. In one embodiment, the markers/tags indicative of the user's selection are displayed directly on the scroll bar, such that it makes it easier for the user to quickly jump back and forth between the marked items. The user may select an item to be marked, e.g., by clicking on an item in the scrollable presentation of the search results. Respective distances between the markers created on the scroll bar are presented as scaled, based on the number of items that have been scrolled through. For example, as the number of scrolled-through items increases, the markers in the scroll bar associated with the bookmarked items appear closer together. In one embodiment, a user can use a pointing device (e.g., a mouse) to hover over markers that have been placed onto the scroll bar to see thumbnail images of the tagged item listings. The scroll map system 121 may be configured to offer an option to perform a “more like these” new search using one or more attributes from the bookmarked item listings. The marked item listings may be saved by a user for later reference.

Returning to FIG. 1, the payment applications 122 may provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs client-server architecture, the subject matter of the application is of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

The integration module 107 on the client machine (e.g., a laptop computer, desk top computer, or mobile phone) may submit requests to the marketplace applications 110, through the API server 114, for an up-to-date (e.g., current) publication related to goods and/or services being offered for sale via the networked system 102. A publication related to goods and/or services being offered for sale may also be termed an item listing. Alternatively or additionally the client machine 110 may request one or more current publications from the client machine 112, via the network 104. In various example embodiments, the client machine 112 may provide a current publication to the client machine 110, after generating the current publication or retrieving such a publication from the networked system 102.

In some example embodiments, the integration module is embedded within one or more of the client applications 105 and may collect user parameters, receive targeted current publications based on the user parameters, and cause the display of one or more targeted current publications. A targeted current publication may be displayed among graphics associated with the application in which the integration module is embedded.

The applications 120, including the scroll map application 121, may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access server one or more databases 126 via the database servers 128.

The networked system 102 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or service.

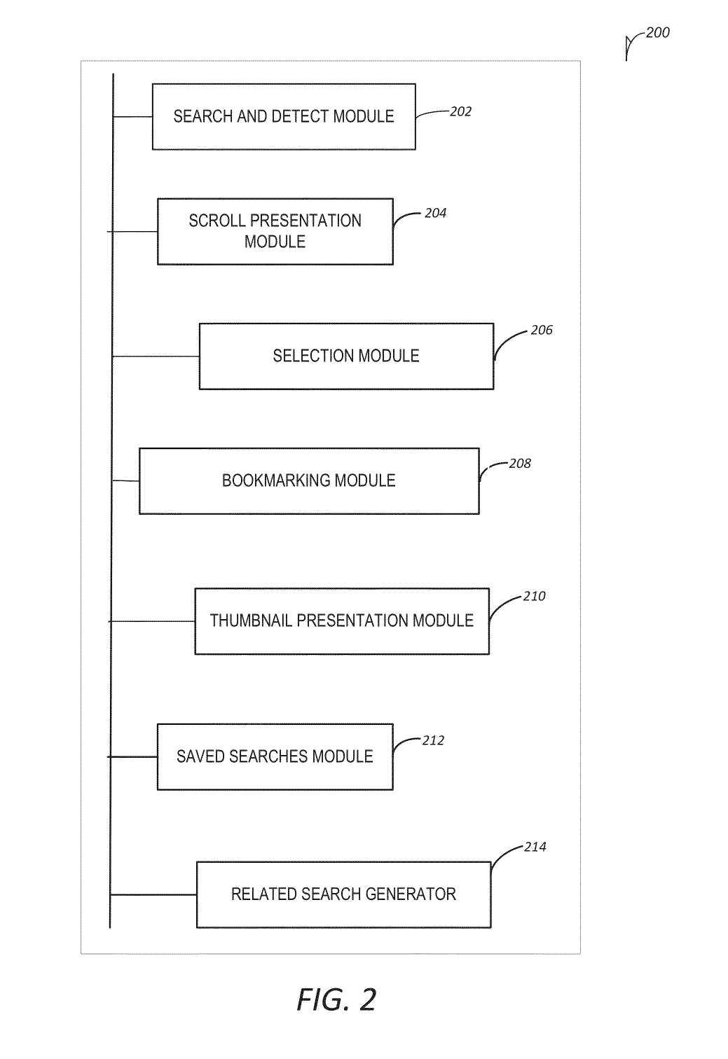

FIG. 2 is a block diagram of a system 200 to provide a scroll map, in accordance with one example embodiment. As shown in FIG. 2, the system 200 may include a search and detect module 202, a scroll presentation module 204, a selection module 205, and a bookmarking module 206. The search and detect module 202 may be used to compare products that are requested for search, or that are returned as a result of the search, with products that are offered by the merchant in whose business the display code, such as the scrolling display, is integrated. The result of the comparison may prevent products that are the same as, or equivalent to, the products offered by the merchant from being displayed. The comparison may be performed before or after the search is made. The scroll presentation module 204 may be configured to present, on a display device, search results as a scroll presentation or otherwise. The scroll presentation comprises a search results area for displaying search results and a scroll bar for scrolling through the search results. As mentioned above, the search results comprising items representing respective listings. The selection module 206 may be configured to identify a certain listing from the search results in response to a selection request associated with the certain listing. The bookmarking module 208 may be configured to display a marker associated with the selected listing directly on the scroll bar. As mentioned above, the scroll presentation may be in the form of an “infinite” scroll bar that permits navigating through search results without using pagination. The bookmarking module 208 may also be configured to display markers on the scroll bar spaced in a manner indicative of a number of listings in the search results that have been scrolled through, such that two markers are positioned closer together as a number of scrolled-through listings increases.

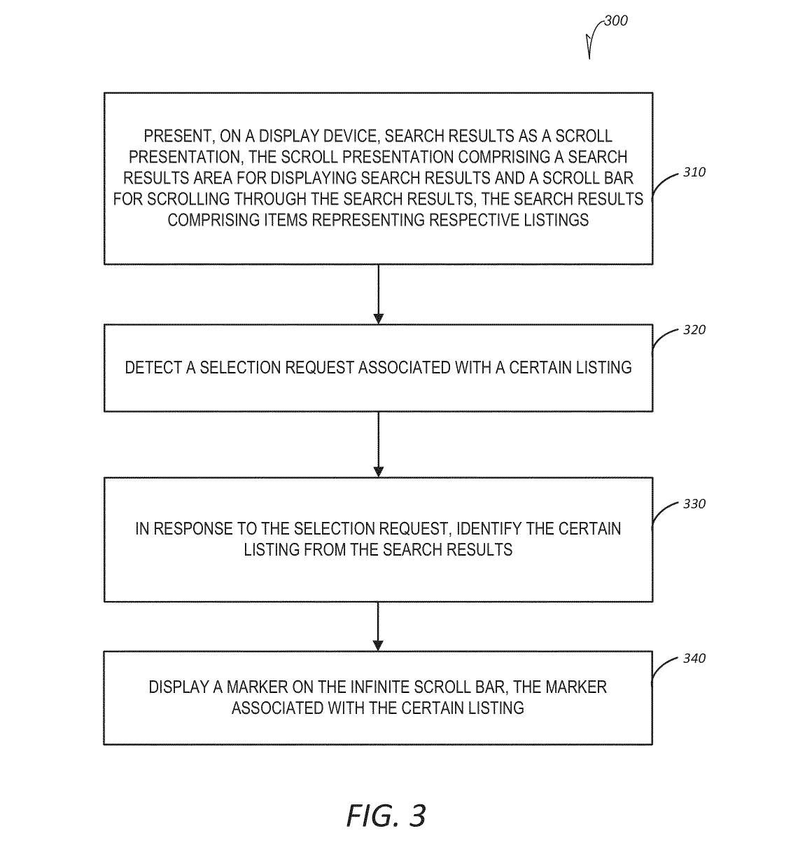

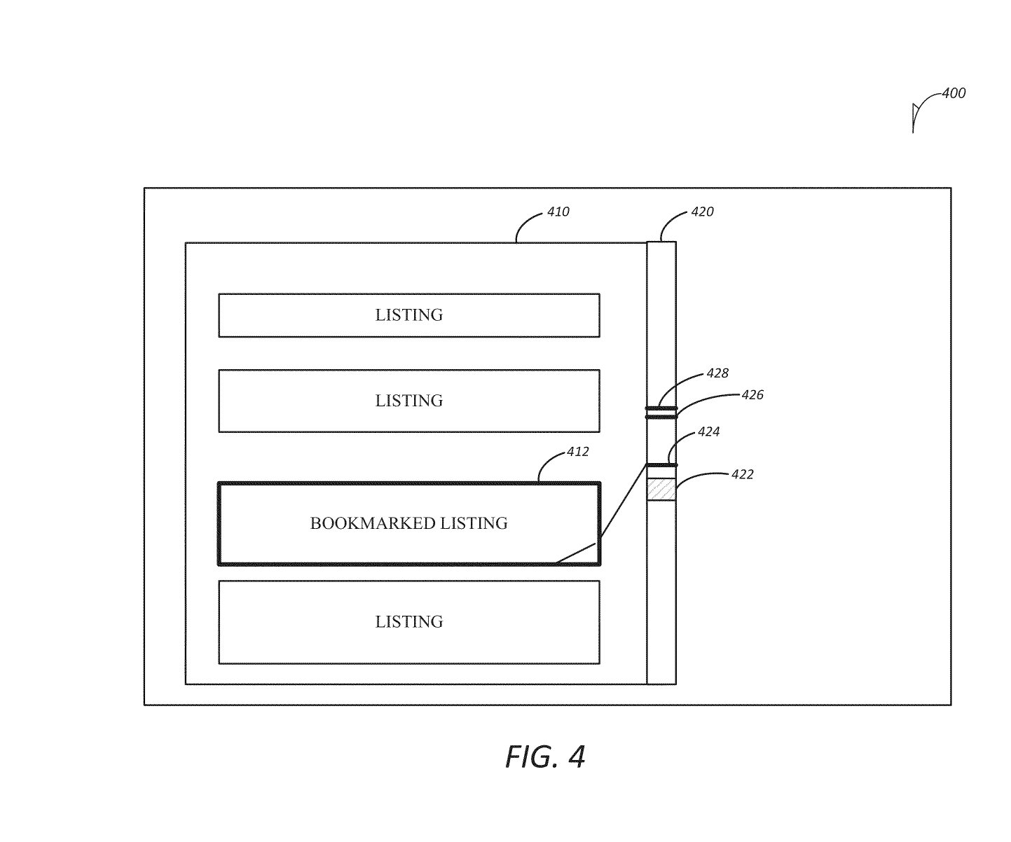

Also shown in FIG. 2 is a thumbnail presentation module 210. The thumbnail presentation module 210 may be configured detect an event associated with the selected listing, e.g., a hover of a pointing control, and present a thumbnail image of an item associated with the listing, over which the pointing control is hovering. The system 200 may also include a saved searches module 212. The saved searches module 212 may be configured to generate a list of saved searches comprising listings from the search results that are associated with respective markers on the scroll bar. As mentioned above, a user may be presented with an option to perform a search intended to produce further results that are similar to the bookmarked items. A related search generator 214 may be configured to present an option to perform such new search. Such new search may be generated by the related search generator 214 using one or more attributes of the elected/bookmarked listing. The related search generator will interact with the search and detect module 202 which functions as discussed above, except that the function in this case is with respect to a related search. An example method to provide a scroll map can be described with reference to FIG. 3. An example method of the search and detect function discussed above is described with reference to FIG. 4.

FIG. 3 is a flow chart of a method 300 to provide a scroll map, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 118 of FIG. 1 and, specifically, at the system 200 shown in FIG. 2.

As shown in FIG. 3, the method 300 commences at operation 310, when the scroll presentation module 202 of FIG. 2 presents, on a display device, search results as a scroll presentation that comprises a search results area for displaying search results and a scroll bar for scrolling through the search results. At operation 320, a selection request associated with a listing from the search results is detected, and the selection module 204 identifies a listing from the search results at operation 330. The bookmarking module 206 of FIG. 2 displays a marker associated with the selected listing directly on the scroll bar, at operation 340. As mentioned above, the markers on the scroll bar may be spaced in a manner indicative of a number of listings in the search results that have been scrolled through, such that two markers are positioned closer together as a number of scrolled-through listings increases.

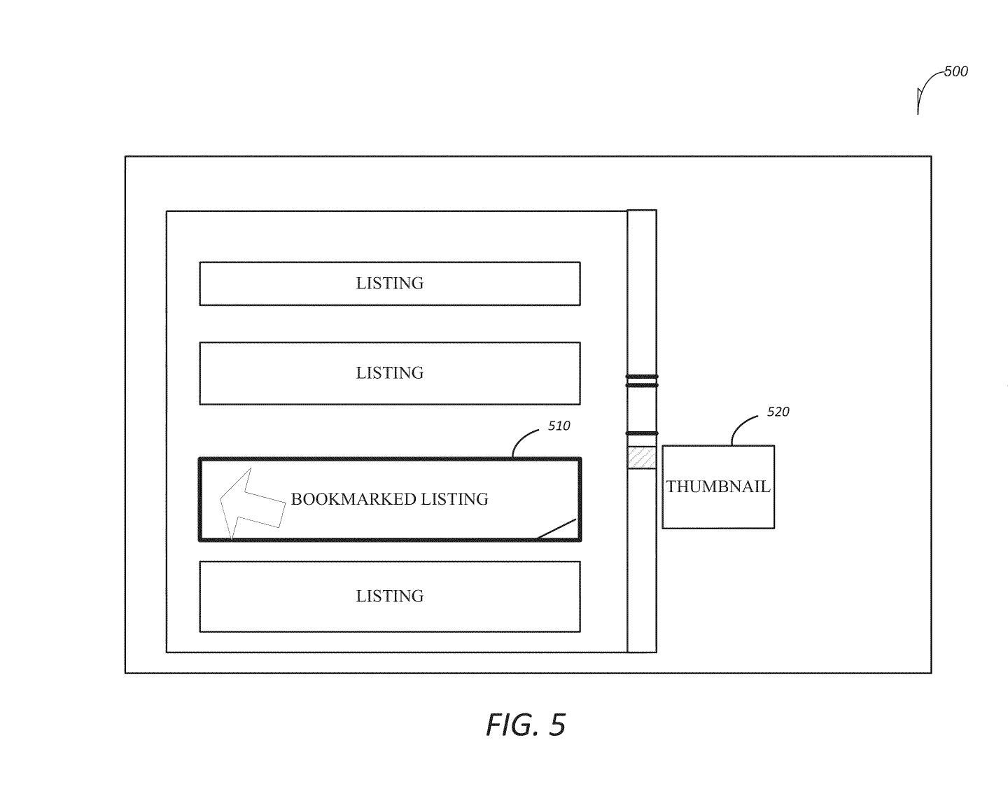

An example scroll presentation 400 is illustrated in FIG. 4, according to an embodiment. The scroll presentation 400 may comprise a search results area 410 and a scroll bar 420. The listing 412 is shown with a thicker border to indicate that it has been selected by a user and bookmarked by the system 200 of FIG. 2. The scroll bar 520 comprises a scroll box 422, and markers 424, 426, and 428. The marker 424 is associated with the position of the listing 412 in the search results list. FIG. 5 shows an example user interface 500 to display a thumbnail image 520 of a bookmarked listing 510, in accordance with an example embodiment.

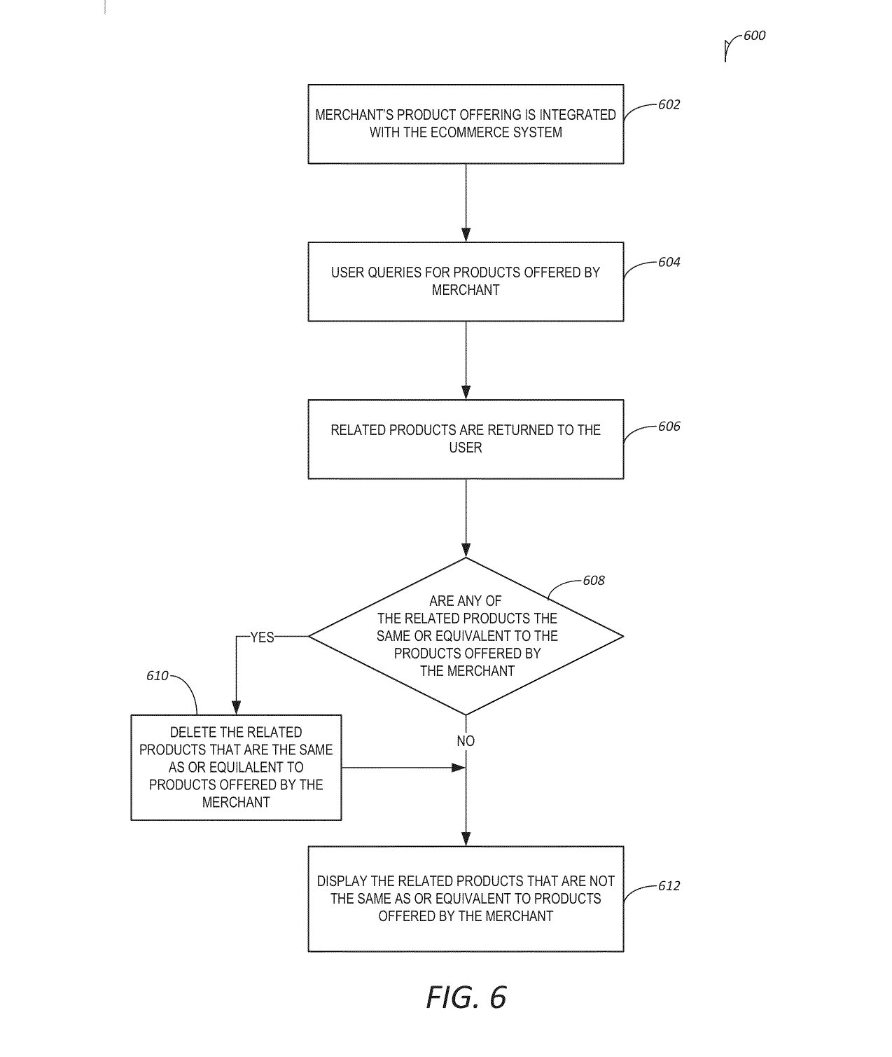

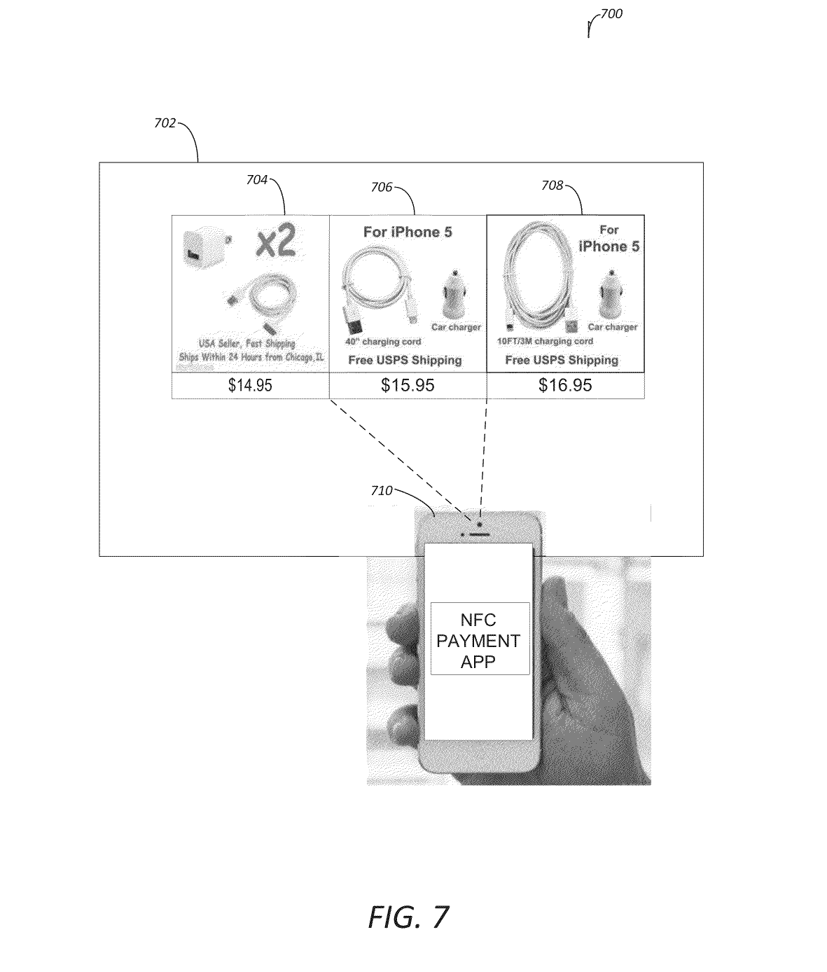

FIG. 6 is a flowchart of a method 600 used in one embodiment. The method begins when the display code, such as the above described carousel code, has been integrated into the merchant's business. For example, the display code may be installed in the merchant's website and coupled to an ecommerce system. At 602 the merchant may integrate his or her own product offerings with the ecommerce system. For example, the ecommerce system may receive from the merchant information that is utilized by the ecommerce system to generate listings of products. Further, the ecommerce server may store the listings that have been generated in one of the databases 126 of FIG. 1. At 604, at an appropriate time, a user, at a client machine may enter a query that is received by the ecommerce system which processes the query to identify specific products that are being offered by the merchant. At 606 related products are returned from the ecommerce server responsive to the query. This may be accomplished by the user querying for a product offered by the merchant. The ecommerce system may receive the query and, and in response, may search its databases for products related to the queried product offered by the merchant, such as accessories for the offered product. For example, if the user queries for an offered product such as an iPhone, the ecommerce system may receive the query and search its servers for products related to an iPhone, delete from the returned display of related products those products that are offered by the merchant, and return the remaining related products in a display such as the carousel described above. The merchant may not, in this example, offer iPhone charging cables and associated items such as seen at 704, 706, and 708 of FIG. 7, resulting in the related, or accessory, products returned in the display of FIG. 7. These products may be products that are listed for sale on or via the ecommerce site. In another embodiment, the user may query for the related item itself if desired.

At 608, the ecommerce system may make a comparison between the returned related products and those products offered by the merchant which, as mentioned above, may be stored in the database 126 of FIG. 1. The comparison may be performed by the compare and detect module 202 of FIG. 2 which may make the comparison described in the previous sentence and detect those returned related products that are the same or equivalent to products offered by the merchant. In some embodiments the comparison may be implemented to detect only returned related products that are the same as the products offered by the merchant. In another embodiment the comparison may be implemented in the client. If none of the returned related products are the same as or equivalent to products offered by the merchant, the NO leg is taken from decision point 608 and at 612 the returned related products are displayed on the merchant's website for purchase from a seller of those related products on the ecommerce system. If the comparison results in the YES leg being taken, then at 610 the returned related products that are the same as or equivalent to the products offered by the merchant are removed from the returned products and, at 612, the remaining related products are displayed. The related products may then be selected for purchase or for other purposes by using ecommerce selection processes via the client machine which may be a laptop, stationary computer, or mobile device. One embodiment of selection will be discussed in more detail below.

FIG. 7 is a diagram of a user interface 700, according to one example embodiment, for display and selection. For example the user interface 700 is being shown to illustrate a display of products and a selection of one or more products using near field communication (NFC). As seen in FIG. 7, the user interface may include a display 702, which could be a scrolling display as discussed above, or a stationary display board, which may be implemented with the ability to communicate with a mobile device by near field communication. NFC is a set of standards for smartphones and other mobile devices to establish radio communication with each other or with other devices such as displays, by touching them together or bringing them into close proximity, usually no more than a few centimeters. Present and anticipated applications may include contactless transactions, data exchange, and setup of more complex communications such as Wi-Fi. Communication is also possible between an NFC device and an unpowered NFC chip, called a “tag”. NFC standards cover communications protocols and data exchange formats, and are based on existing radio-frequency identification (RFID) standards including ISO/IEC 14443 and FeliCa. The standards include ISO/IEC 18092 and those defined by the NFC Forum, which was founded in 2004 by Nokia, Philips® and Son®. On display 702 are seen related products 704, 706, 708, displayed as in step 412 of FIG. 4. The display may be via the above carousel code, or on a standard user interface generally used by ecommerce systems. The display 702 may be website or in the merchant's physical store or in a merchant store in an electronic mall. The querying may be carried out as discussed with respect to FIG. 4 by any of the querying means described above. In addition, a mobile device 710, like display 702, is NFC enabled, and the selection process may be initiated using NFC communication between the mobile device 710 and the display 702 by bringing the two devices into near or close contact, as illustrated in FIG. 7. A desired related product may be selected in one embodiment by bringing the mobile device in close proximity to the desired related product at the display.

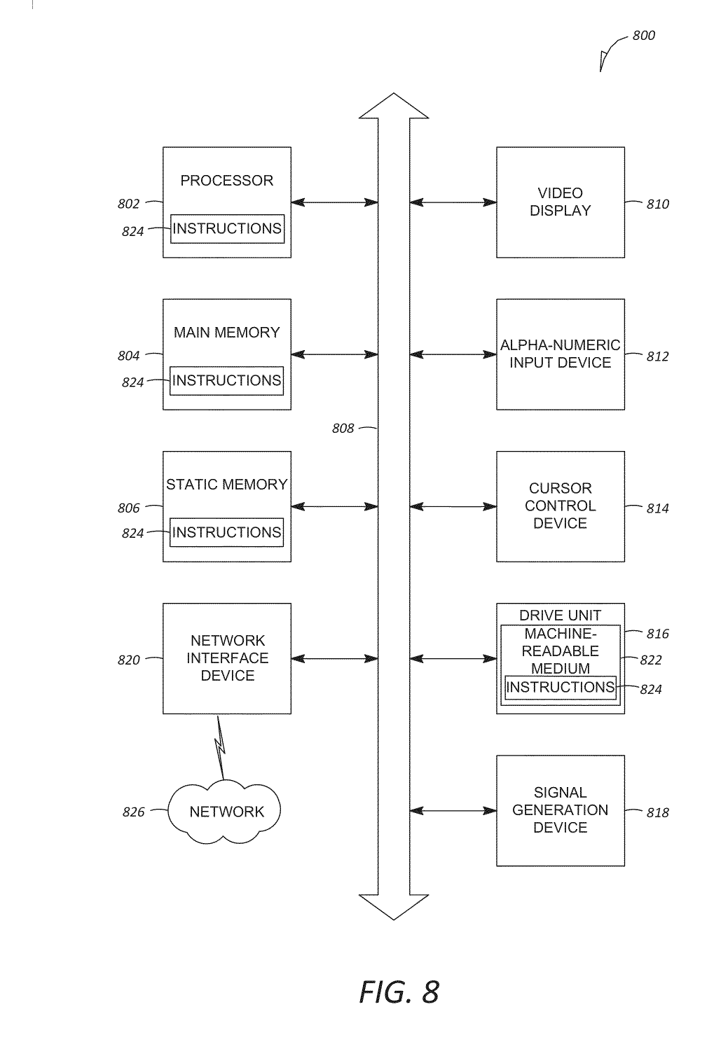

FIG. 8 is a diagrammatic representation of a machine in the example form of a computer system 800 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 806. The computer system 800 may further include a video display unit 810 (e.g., a liquid crystal display (LCD) or a cathode ray tube (CRT)). The computer system 800 also includes an alpha-numeric input device 812 (e.g., a keyboard), a user interface (UI) navigation device 814 (e.g., a cursor control device), a disk drive unit 816, a signal generation device 818 (e.g., a speaker) and a network interface device 820.

The disk drive unit 816 includes a machine-readable medium 822 on which is stored one or more sets of instructions and data structures (e.g., software 824) embodying or utilized by any one or more of the methodologies or functions described herein. The software 824 may also reside, completely or at least partially, within the main memory 804 and/or within the processor 802 during execution thereof by the computer system 800, with the main memory 804 and the processor 802 also constituting machine-readable media.

The software 824 may further be transmitted or received over a network 826 via the network interface device 820 utilizing any one of a number of well-known transfer protocols (e.g., Hyper Text Transfer Protocol (HTTP)).

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, method and system to provide a scroll map have been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

1. A system to display products at a merchant business, the system comprising:
at least one processor and at least one storage device that are configured to:
receive from a client machine listing information that describes a first plurality of products that are offered for sale by the merchant business;
determine a second plurality of products that are related to the first plurality of products but are not the first plurality of products; and
communicate to a client machine images of the second plurality of products for display in association with the merchant business, the second plurality of products are for purchase on an ecommerce system via the merchant business.

2. The system of claim 1 wherein the images of the second plurality of products are displayed by code in a scrollable carousel-like appearance of products.

3. The system of claim 2 wherein the code is provided by the ecommerce system.

4. The system of claim 2 wherein the code is integrated with the merchant's website.

5. The system of claim 2 wherein the code is integrated with a display in the physical store of the merchant.

6. The system of claim 2 wherein the code is integrated with a store of the merchant in an electronic mall.

7. The system of claim 1 wherein the images of related products are displayed on a display that is enabled to function using near field communication, and the images respectively are selectable by a mobile device that is enabled to function using near field communication.

8. A method to display products at a merchant business, the method comprising:
receiving by a computer processor, from a client machine, listing information that describes a first plurality of products that are offered by the merchant business;
determining a second plurality of products that are related to the first products but are not the first plurality of products; and
communicating to the client machine images of the second plurality of products that were determined to be related to the first plurality of products but are not the first plurality of products, for display in association with the merchant's business for purchase on an ecommerce system via the merchant business.

9. The method of claim 8 wherein the images of the related products are displayed by code in a scrollable carousel-like appearance of products.

10. The method of claim 9 wherein the code is provided by the ecommerce system.

11. The method of claim 9 wherein the code is integrated with the merchant's website.

12. The method of claim 9 wherein the code is integrated with a display in a physical store of the merchant.

13. The method of claim 9 wherein the code is integrated with a store of the merchant in an electronic mall.

14. The method of claim 8 wherein the images of related products are displayed on a display that is enabled to function using near field communication, and the images are respectively selectable by a mobile device that is enabled to function using near field communication.

15. A non-transitory computer-readable storage device having embedded therein a set of instructions which, when executed by one or more processors of a computer, causes the computer to execute the following operations:
receiving a listing of a plurality of first products offered by a merchant business;
determining a plurality of second products related to the plurality of first products but that are not the plurality of first products; and
communicating images of the plurality of second products for display in association with the merchant's business for purchase on an ecommerce system via the merchant business.

16. The non-transitory computer-readable storage device of claim 15 wherein the images of the related products are displayed by code in a scrollable carousel-like appearance of products.

17. The non-transitory computer-readable storage device of claim 16 wherein the code is integrated with the merchant's website.

18. The non-transitory computer-readable storage device of claim 16 wherein the code is integrated with a display in a physical store of the merchant.

19. The non-transitory computer-readable storage device of claim 16 wherein the code is integrated with a store of the merchant in an electronic mall.

20. The non-transitory computer-readable storage device of claim 18 wherein the display is enabled to function using near field communication, and the images are respectively selectable by a mobile device that is enabled to function using near field communication.

21. A system comprising:
at least one computer processor and storage; and
a non-transitory computer-readable storage device having embedded therein a set of instructions which, when executed by one or more processors of a computer, causes the computer to execute the following operations:
receiving a listing of a plurality of first products offered by a merchant business;
determining a plurality of second products related to the plurality of first products but that are not the plurality of first products; and
communicating images of the plurality of second products for display in association with the merchant's business for purchase on an ecommerce system via the merchant business.
